(19) United States
(12) Patent Application Publication
(10) Pub. No.: US 2002/0070548 A1
(43) Pub. Date: Jun. 13, 2002

(54) Induction port assembly for impactors and method of assembly

(76) Inventors: Daryl L. Roberts, Blaine, MN (US); Virgil A. Marple, Maple Plain, MN (US)

Correspondence Address: WESTMAN, CHAMPLIN & KELLY, P.A., International Centre - Suite 1600, 900 Second Avenue South, Minneapolis, MN, 55402-3319, US

(21) Appl. No.: 09/733,114

(22) Filed: Dec. 8, 2000

(51) Int. Cl. F16L 43/00

(52) U.S. Cl. 285/179

(57) ABSTRACT

An induction port assembly that conforms to United States Pharmacopia Standards is formed of stainless steel, and is made in two sections that are welded together along a junction plane at a 45° angle to the axes of the tubular sections. The stainless steel induction port assembly is reduced in weight, by using thin wall sections, and includes coupling sections at the outer ends of the tubular portions. The coupling sections can be hardened on the outer surfaces that couple to other components. The interior surface of the tubular induction port assembly is polished after welding to the desired standards.

### BACKGROUND OF THE INVENTION

The present invention relates to a metal induction port assembly that conforms to USP Standards and maintains substantially the same weight as that of an aluminum inlet or induction port, but is made of corrosion resistant stainless steel and are electrically conductive.

The inlet ports for cascade impactors for measuring particle distributions use an inlet member or induction port that must conform to USP Standards. At present weight saving is a major concern, and the present USP inlets that are made are made of materials that are lightweight, but which are not resistant to particle abrasion, nor generally are they electrically conductive so as to avoid static charge build-up.

Aluminum inlets are commonly made, but the mitered corners are generally held together with screws and the tube walls are left with thick tube walls and a large outside diameter, matching the diameter of the connectors. Also, anodizing and oxides that form cause the surfaces to be electrically insulating, so static charge builds up, which causes particles to cling to the interior surfaces.

The present invention provides an inlet port or induction port assembly that is corrosion resistant, abrasion resistant, and electrically conductive.

### SUMMARY OF THE INVENTION

The present invention relates to a stainless steel induction port assembly for USP Standard inlets for compactors. The USP inlet is a right angle conduit that has standardized internal dimensions for connecting to standard couplings.

In order to make the device out of stainless steel and keep the weight down, the inlet is formed as two tubular sections of reduced thickness, except for standard size end members that fit into the standard couplings. The two tubular sections have machined, mitered ends that are precisely made so that the miters fit together to form the right angle passageway. The two tube sections are then welded with the sections held precisely in registry. The welding is carefully done so that it does not penetrate into the interior surfaces of the tubular passageways.

After welding, the interior surfaces of the tubular passageways, which now form right angles, are polished to a surface that is at least no rougher than 16 micro inches, to conform to the desired requirements of the USP Standards.

The ends that are coupled to couplings have tapered outer surfaces that increase in diameter in direction away from the ends. The tapered surfaces that fit with couplings are hardened with a titanium nitride coating, before welding, so that they have hardened surfaces to avoid wear from repeated coupling and uncoupling the induction port assembly.

A very dependable, long lasting, and functional inlet or induction port assembly is thus formed with stainless steel, without increasing the weight over those presently used, but having the added advantages of the properties of stainless steel in this application.

### BRIEF DESCRIPTION OF THE DRAWINGS

FIG. 1 is a cross sectional view of an USP induction port assembly made according to the present invention;

FIG. 2 is a sectional view of a first portion of the induction port assembly of FIG. 1; and

FIG. 3 is a sectional view of a second portion of the induction port assembly of FIG. 1.

### DETAILED DESCRIPTION OF THE PREFERRED EMBODIMENTS

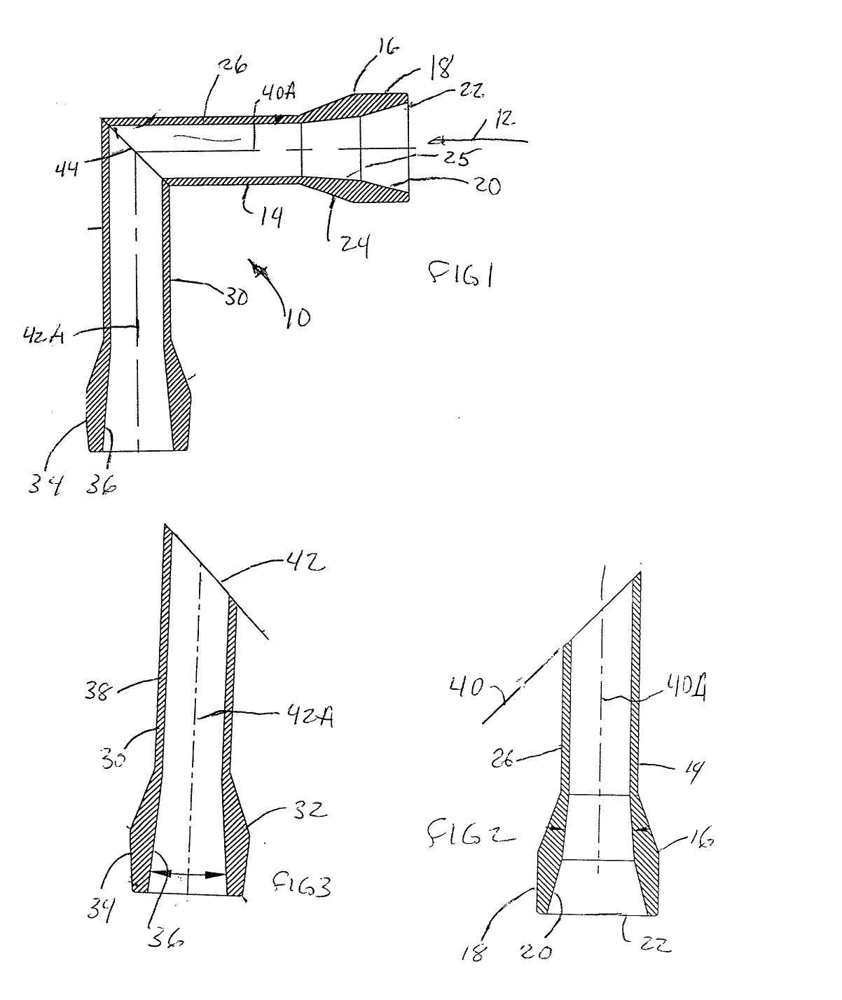

In FIG. 1 an USP induction port assembly is indicated generally at 10, and it is designed to receive an aerosol from one end as indicated by the arrow 12. The aerosol has particles that are to be classified. The induction port assembly 10 is made to direct the aerosol flow into a classification instrument, called an impactor, or to a similar instrument. The airflow goes through a first tubular section 14 that has a standard coupling end 16 with an outer tapered surface 18, and an inner conically tapered surface 20. The outer tapered surface increases in diameter from the end plane 22, to a set desired size, and then the coupling tapers toward a central axis of the tube with an inwardly tapered surface 24. The tapered surface 24 joins the outer surface of the tubular section shown at 26.

The inner inwardly tapered surface 20 tapers from a larger diameter at the end plane 22 to the desired size, and as shown, the inwardly tapered surface 20 joins a second more gently tapered surface section 25.

The tubular section 14 mates with a second tubular section 30 that has an end coupling member 32 which is formed with an outer tapered surface 34 that mates with a second form of standard coupling. Coupling member 32 is different from the coupling 16. The tubular section 30 has an end inwardly tapered surface 36 which is more gently tapered than the surface 20, and leads to the inner diameter of a tube portion 38 of the tubular section 30. The two tubular sections 14 and 30, are each precisely machined at their ends opposite from the coupling along miter planes indicated at 40 and 42, respectively, in FIGS. 2 and 3. These surfaces 40 and 42 are very precisely machined to be at 45° angles to the longitudinal axes 40A and 42A of the two tube sections respectively.

Once these surfaces have been precisely machined, and the coupling ends have been machined in place, the two parts are two tubular sections 14 and 30 are placed at right angles as shown in FIG. 1. The central axes 40A and 42A of the tubular sections intersect. The seam or junction indicated at 44 between the two parts is welded by electron beam welding or similar controllable depth welding, after all surfaces have been precisely matched up, to hold the two tubular sections in assembly. The electron beam welding is done in a manner so that there is no perturbation to the inside surfaces of the tubular sections, at the junction 44. In other words the surfaces mate precisely, and no weld breaks through to the interior surface of the tubes, so that the flow is not disrupted or caused to become turbulent due to any weld.

In this manner, the flow is maintained on a desired level. Prior to welding, the outer conical surfaces 18 and 34 can be hardened with a suitable hardening coating, such as titanium nitride applied in a known manner. The weight reduction that permits using stainless steel is obtained by having thinner walls of the tubular sections. The outer diameter as shown is 24 millimeters and the inner diameter is 19 millimeters, leaving a wall thickness of 2.5 mm. This thickness is adequate for strength and abrasion resistance, while being light weight. The tubes are machined to taper to a smaller diameter from the connectors. The surfaces of stainless steel do not oxidize and remain conductive so static charge does not build up.

In the process, after welding the parts into the assembly shown in FIG. 1, the inner surfaces of the tubes are polished in a known manner to a surface that is at least 16 micro inches or less, to conform to the USP (United States Pharmacopeia) Standards.

The USP induction port assembly made according to the present invention thus is ready to install, and will provide for a lightweight, highly durable induction port assembly.

Although the present invention has been described with reference to preferred embodiments, workers skilled in the art will recognize that changes may be made in form and detail without departing from the spirit and scope of the invention.

What is claimed is:

1. An induction port assembly comprising a tubular member having first and second tubular portions positioned at right angles to each other, a first coupling at an outer end of the first tubular section, and a second coupling at an outer end of a second tubular portion, said USP induction port assembly being made of stainless steel.

2. The induction port assembly of claim 1, wherein said first and second tubular portions are formed separately, and a weld holding the tubular portions together at a junction line.

3. The induction port assembly of claim 2, wherein said two tubular sections join along surfaces formed on planes at 450 to longitudinal central axes of the respective tubular portions.

4. A method of forming an induction port assembly of a stainless steel material comprising the steps of forming first and second tubular sections having coupling ends, and having junction ends opposite from the coupling ends, said junction ends being machined such that the junction ends have defined planes at 45° to central longitudinal axis of the tubular sections, placing the junction ends in registry to position the central axes of the respective tubular sections at 90° to each other and intersecting, and welding along the outer surfaces of the junction between the two tubular sections without penetrating the interior surface.

5. The method of claim 4, including the further step of polishing interior surfaces of said tubular sections subsequent to welding.

6. The method of claim 4, wherein said welding is electron beam welding that leaves no perturbations on the interior of the induction port assembly.

7. The method of claim 4, including the step of hardening the exterior surfaces of the couplings at both of the tubular sections.

8. The method of claim 4, including tapering the outer surfaces of the couplings at the ends of the tubular sections, prior to welding, and coating the tapered outer surfaces with a hardening coating comprising titanium nitride.
